(19) United States
(12) Patent Application Publication
(10) Pub. No.: US 2016/0191549 A1
(43) Pub. Date: Jun. 30, 2016

(54) RICH METADATA-BASED NETWORK SECURITY MONITORING AND ANALYSIS

(71) Applicant: Glimmerglass Networks, Inc., Hayward, CA (US)

(72) Inventors: An Nguyen, Oakland, CA (US); Xiongwei He, San Jose, CA (US); Jerry Miille, San Ramon, CA (US); Steve Ernst, Walnut Creek, CA (US); Jason C. Wong, Fremont, CA (US)

(21) Appl. No.: 14/876,553

(22) Filed: Oct. 6, 2015

Related U.S. Application Data
(60) Provisional application No. 62/061,845, filed on Oct. 9, 2014.

(51) Int. Cl. H04L 29/06

(52) U.S. Cl. CPC H04L 63/1416; H04L 63/1425

(57) ABSTRACT

Network security monitoring for external threats is provided that is based on rich metadata collected from internal network traffic that is analyzed for anomalies against a behavior baseline to detect the external threats. Rich metadata includes but is not limited to the information typically found in the headers of every layer of telecommunication protocols describing the communication between network entities.

### CROSS-REFERENCES TO RELATED APPLICATIONS

The present application claims benefit under 35 USC 119(e) of U.S. Provisional Application No. 62/061,845, filed on Oct. 9, 2014, entitled “RICH METADATA-BASED NETWORK SECURITY MONITORING AND ANALYSIS,” the content of which is incorporated herein by reference in its entirety.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates to tools for network administration and more particularly to a method and apparatus for monitoring and analysis of a packet-based digital communication network to protect against external threats.

Today's enterprise networks face cyber attacks of increasing intensity and complexity. Almost every day there are reports of cyber attacks and data breaches despite billions of dollars already spent on enterprise security solutions. Clearly there are shortcomings in the current set of cyber security solutions.

Packet capture and analysis tools such as Wireshark (Wireshark Foundation) are counted as some of the most valuable ones in security analysts' toolbox. These tools provide great details for forensic analysis. In a high speed data communication environment, the amount of data quickly overwhelms anyone attempting to look through the network traffic over a span of more than a few minutes or a a few seconds. The sheer volume of traffic renders impractical if not impossible the monitoring and analysis of the network on a long-term and continuous basis.

SIEM-based solutions are widely used by enterprises to detect attacks. SIEM applications use application logs or security logs to find anomalous or suspicious activities that happened on network nodes. Network nodes can be PCs, servers, switches, routers, etc. SIEM-based solutions are fundamentally limited by how rich the logs are designed and implemented. Their effectiveness is further reduced if logging is not enabled on some network nodes.

Firewall, IDS, IPS and sandbox-based threat detection systems are the most important part of today's enterprise network defense systems. They are designed to create a secure perimeter to protect enterprise networks. When it works, they represent a great solution to guard against attacks. Unfortunately, these systems typically detect threats using known signatures and pre-defined rules. Nowadays, threat actors become increasingly sophisticated. They have learned how to evade detection by perimeter-based security systems. As a result, over 30% of cyber attacks succeed in passing through perimeter-based security systems. New solutions are needed to counter increasingly sophisticated attacks.

### The Need to Monitor the Internal Network

A significant portion of cyber attacks succeed in passing through the perimeter defense of enterprise networks. Once inside the network, attackers have a free hand to conduct malicious activities: to steal sensitive information, paralyze the operation of parts of the network, etc. These malicious activities are sometimes undetected for months or even years because they are not under the watch of any perimeter-based security systems. Their activities are often invisible to SIEM-based systems.

Most of internal network activities are not monitored today. Monitoring the internal network activities would give security analysts great visibility into the parts of the network they typically do not observe. This increased visibility would give security analysts much-needed help to detect and stop malicious activities that would otherwise be unnoticed and undisturbed for months. It is technically possible to monitor internal networks, but is a daunting prospect from cost, performance, and policy management/false positive standpoints.

FIG. 1 is a diagram showing a conceptual illustration of how an Advanced Persistent Threat (APT) happens in a network. It shows that only by monitoring the inside the enterprise network, one can possibly have a chance to see the whole attack scenario, connect the different steps together, detect and stop the attacks before it is too late. This detection is possible even if the attacks are carried using normal communication.

Internal network monitoring has been done before using full packet capture approach. What is preferred is to capture and examine every packet flowing through the internal network. In reality this is not practical. Several problems exist with full packet capture based solution: 1) the amount of the data captured would be too voluminous to be effective. (For one single 1 Gb/s full-duplex link, at peak rate, there will be 250 MB of data captured per second. For one hour, 900 GB of data would be captured. Over 20 TB of storage space would be needed to store one day worth of data. Storage space would cost an exorbitant amount of money); 2) In addition to the storage problem, huge computing power needs to be available to process the amount of data captured in order to detect the threats “buried” in mountains of data. A different approach is needed.

### SUMMARY OF THE INVENTION

According to the invention, network security monitoring is provided that is based on “rich metadata” collected from internal network traffic that is analyzed for anomalies to detect threats. To do so, network traffic is tapped at critical points of the internal network. Direct links bring tapped traffic to metadata probes. Metadata of every traffic flow is extracted automatically on a continuous basis by the probes. The extracted data are then aggregated into a big data cluster to provide instant insights to security analysts without requiring time-consuming searching through a huge amount of data. The same data can be used for real-time detection of anomalies and network attacks by analytics software. The solution also protects sensitive data and provides insight into the use of content within the enterprise network. It helps organizations better understand their data traffic and improved their ability to classify network activities and manage content. An embodiment of the invention targets smaller enterprise networks to simplify management as well as reduce the system cost and improve performance based on a consolidated architecture and the novel metadata-based analysis under an unified system control management.

Although end-to-end encryption may protect the content of the message, metadata still can be captured even when encryption is applied. By “rich metadata” it is meant at least information found in the headers of every layer of protocols associated with digital communication. This information describes the communication between two or more network entities. Such communication can be the result of human user actions such as a user browsing a web page. It can also be an autonomous action taken by the software running on a computer, such as a DHCP request automatically sent to acquire a dynamic IP address for a computer. Metadata contains critical information exchanged between network entities that can help security analysts quickly understand at a high level what type of communications happened and between which network entities. Such metadata typically represent up to 5% of total flow traffic. By going as deep as possible into all layers of an OSI stack, critical information about all network traffic flows can be extracted, thus enabling the understanding of behavior patterns not only at individual network entity level but also at entire logical network level. When connecting internal network traffic metadata to network users' information, one can enable the development of capabilities that detect human users' behavior on the internal enterprise network. This opens up a set of analysis possibilities that can lead to fast and accurate detection of network attacks while reducing false positives to a minimum. Herein after is a high level architecture view of a possible end-to-end network security monitoring and threat detection solution based on continuous rich metadata flows extracted from internal network traffic.

Further according to the invention, key points of the internal network are monitored and rich metadata of network flows are extracted. In addition, techniques of keeping track of unique IP addresses observed in the internal network are provided that give security analysts the ability to see new actors in their networks in real time.

Further, techniques are provided to automatically capture the mapping from IP address to MAC address and to domain name using extracted DNS and DHCP flow metadata. The organization information can be used to map the hostnames, MAC addresses, and phone numbers to real network users who are assigned to the network devices where traffic is originated or terminated. This rich set of mapping information enables a new way of detecting the suspicious actors early before harm is done. Furthermore, creating traffic distribution graphs, traffic patterns, and relationship maps for a network or a particular entity of interest not only paints a much more accurate picture of the monitored network or entity, but also highlights their characteristics, functionality and normality. By combining these aspects, one can derive and analyze the internal network characteristics over time, which is crucial to develop a powerful and sophisticated anomaly detection system with low false positives. Generally, the anomaly behaviors can be discovered by the following methods:

1. Analytics: The analyst views the analytics provided by the cyber security tool. The analytics provides visualizations of the traffic over time, the applications and protocols, device statistics, relationships, etc. Often, the analyst can “spot” anomalous behaviors from these analytics.

2. Policies/Rules: The analyst creates rules to detect anomalous behaviors. In our solution, these rules can be created against any of the captured metadata. Rules are often categorized as follows:

a. Simple (event driven)

b. Volumetric

c. Temporal

d. Spatial

e. Comparison

f. Dependent

g. Boolean

h. Nested

(The details for each of these are outside the scope of this document. Rules can be complex and may require a strong understanding of networking and security. For this reason, solutions often include templates to help the analyst create comprehensive rules.)

3. Machine Learning and Automation: The cyber security solution “learns” the normal behavior of the network users and entities. Once this “baseline” is established, the machine can also be employed to detect deviations from the normalcy, thus automating the threat detection process. The analyst can still create policy engine rules, but they can become much more sophisticated. For instance, a rule could issue an alert upon traffic levels dropping by a specified percentage. Most often, both machine learning and sophisticated policy rules are used with such solutions.

In a specific embodiment, the proposed solution is to monitor internal network activities among network entities at critical points by continuously extracting a rich set of metadata. By analyzing the extracted metadata, one can create and archive:
A richer definition set of network entity such as employees, dedicated servers by combining existing organization information and equipment record.
Role classification of network entities.
Network traffic patterns between network entities for a given network at a given period of time.
A relationship mapping between network entities for a given period of time or a given set of applications
A normality definition using role, network traffic pattern, and relationship mapping for a network entity for a given period of time.
The dynamic normality definition can be used for anomaly detection for a network entity in near real time.
The ability to track network entities using DNS and DHCP metadata
The ability to let the analysts know when a new entity is introduced to the monitored network and tracking unique entities.

Determining the baseline behaviors for a sophisticated network can be a daunting task. This behavior analysis must consider the time span over which the baseline is determined, the parameters to be baselined, and how those parameters will be categorized. There are at least two choices for the time span:
1. A “learning” period during which all the parameters are learned up front (and are then maintained over time). This upfront period may be as long as several days.
2. “On the fly” learning that occurs as needed. This method can be less accurate (leading to greater false positives). It usually begins when an analyst specifies a rule that needs the parameter(s) to be baselined.

The choice of parameters to be baselined and how those parameters are categorized greatly affect the complexity and responsiveness of the solution. We propose a unique baselining solution that will pivot around users. Specifically, all learned parameters will be categorized to a user.

Other baselining approaches can quickly become very complex and result in large databases, which could become unwieldy for large networks. For instance, one could envision an approach that attempts to baseline every parameter according to every category. So, the challenge is to develop an efficient method to baseline a network user according to a selected set of attributed parameters.

The present baselining approach is a user-centric method. The user is defined to be the entity that creates network traffic. The entity may have a user name (a credential tied to an employee account, for instance); he may have multiple devices that he “normally” uses; he may be associated with “normal” activities, etc.

The invention will be better understood by reference to the following detailed description in connection with the accompanying drawings.

### BRIEF DESCRIPTION OF THE DRAWINGS

FIG. 1 is a (prior art) diagram illustrating the environment of a prior art network facing a threat.

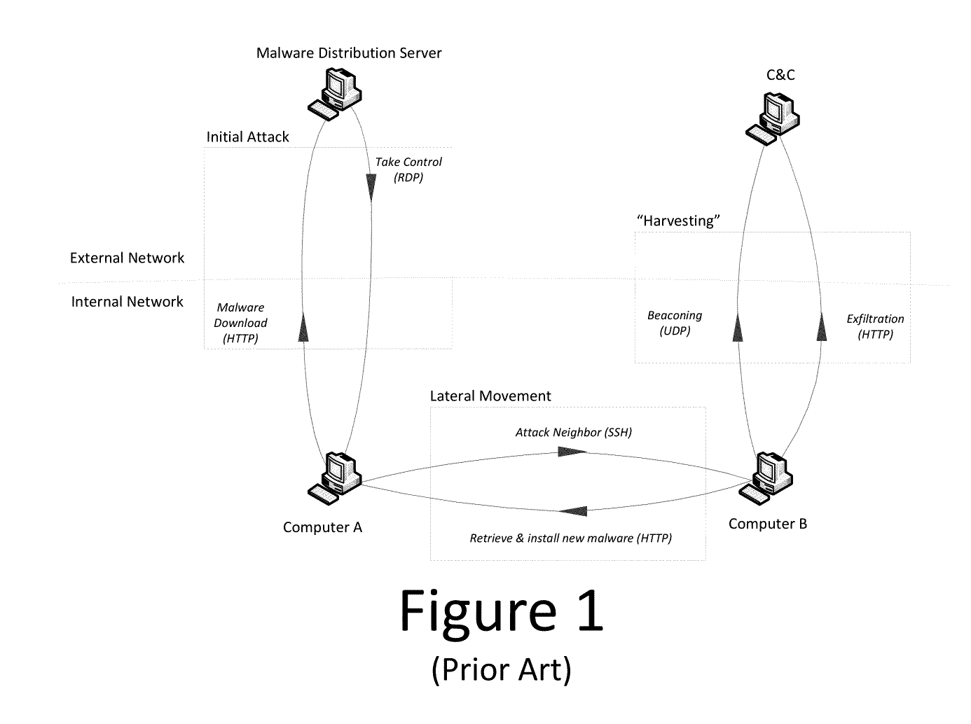

FIG. 2 is a diagram illustrating a network environment of the type admitting to monitoring and threat detection based on rich metadata monitoring and analysis according to the invention.

FIG. 3 is a (prior art) diagram of an array of graphs illustrating network traffic patterns for a given network and a given period of time.

FIG. 4 is a (prior art) detail of a graph visualizing network entities with each other using a specific protocol.

FIG. 5 is a dynamically generated relationship map based on metadata of DHCP and NETBIOS flows according to the invention.

FIG. 6 is an automatically generated VOIP call graph based on rich metadata.

FIG. 7 is a block diagram of the hardware architecture according to the invention.

FIG. 8 is a block diagram of the software architecture according to the invention.

FIG. 9 is block diagram of a design for metadata ingestion according to the invention.

FIG. 10 is block diagram of a consolidated design under unified management control.

FIG. 11 is a block diagram illustrating a process for discovering anomaly behaviors according to the invention.

### DETAILED DESCRIPTION OF THE INVENTION

A metadata probe according to the invention is operative to look into packets as wide and deep as possible to extract the important attributes of all traffic flows under monitoring. As herein defined, it produces a rich set of metadata for the network traffic flows that the probe monitors. Instead of using IP address as a node in an internal network, according to the invention, the probe looks at the network at a more abstract point of view. The probe defines a network entity as either an employee or a device. An employee can be responsible for multiple devices such as laptops, desktops, tablets, and phones. A device can be a web server, DNS server, LDAP server, or any type of machine that has network access. LDAP (Lightweight Directory Access Protocol) servers have an important role in enterprise networks, and LDAP is commonly used by medium-to-large organizations. It not only provides the authentication service, it also holds the enterprise information such as organization information, user information, and server information. When the server starts, the server creates an LDAP client instance to obtain the organization, user, server information to compose a list of network entities, providing directory-like information. For each network server, the application compares the assigned role (such as web server, LDAP server, mail server, file server) to its actual behavior. For example, a server A is expected to be a file server and operate based on the network activity. It behaves as an HTTP server, so it is a suspicious activity; hence, will be flagged. Each user has a telephone number, the information of his or her assigned devices, and a role in the organization. For example, one can create a user Alice whose phone number is 123-456-7890; she has a laptop with the name DOG, and she is a software engineer in Group A in the organization. Alice's information is then used to gather all of the flows related to her, such as SIP phone calls, HTTP traffic, SSH traffic, etc. For each flow, the inventive application compares Alice's behavior against other software engineers as a way of baselining for our anomaly detection. Once can obtain an accurate mapping between network entities to IP addresses, MAC addresses, host names, phone numbers for a given time range while minimizing the traffic generated by the probe itself.

By using organization information (e.g., LDAP), one can obtain the roles of employees and devices within an organization using an internal data network. By comparing behavior of a network entity as herein defined with similar entities, anomalies can be detected. The richness of the metadata based on this approach can be easily illustrated by the following example of an extraction from an HTTP flow:

```
{
      “startTime”: 140571659960530485,
      “endTime”: 140571695997952766,
      “srcMac”: “00:22:69:AB:47:01”,
      “destMac”: “00:17:C5:15:AC:C8”,
      “srcIp”: “192.168.4.109”,
      “destIp”: “198.185.159.135”,
      “srcPort”: 62486,
      “destPort”: 80,
      “protocol”: “TCP”,
      “app”: “HTTP”,
      “hlApp”: “HTTP”,
      “security”: “NONE”,
      “packetsCaptured”: 99,
      “bytesCaptured”: 66540,
      “sessionHistory”: [{
          “method”: “GET”,
          “path”: “/”,
          “referer”:
“http://www.google.com/url?sa=t&rct=j&q=&esrc=s&frm=1&source=web&cd=1&ved=0CB0Q
FjAA&url=http%3A%2F%2Fwww.umbrellasalon.com%2F&ei=cofJU7KECI_3oATe6oKQDg
&usg=AFQjCNGJ0XU-UpJOxMHk-
KOmJEjqPAo6Xg&sig2=7y2VmhPezwelcgjBo9_qmw&bvm=bv.71198958,d.cGU”,
          “host”: “www.umbrellasalon.com”
      },
      {
          “method”: “POST”,
          “path”: “/api/census/RecordHit?crumb=3311960970”,
          “contentType”: “application/x-www-form-urlencoded; charset=UTF-8”,
          “referer”: “http://www.umbrellasalon.com/”,
          “host”: “www.umbrellasalon.com”,
          “cookie”:
“SlNFU1NJT05JRD1zZ3V1emM2eDF6OWMxOXRwbmY2ZjdkYXZ5OyBjcnVtYj0zMzExO
TYwOTcwOyBTU19NSUQ9MzZmYjI4YjQtMGZlYS00YWY4LWFlNmItODg2ZDhiODkyN
GZmaHhyejdyNWI=”
          }
      ],
      “userAgent”: “Mozilla/5.0 (compatible; MSIE 10.0; Windows NT 6.1; Trident/6.0)”,
      “srcLocation”: {
          “countryName”: “Local”,
          “countryCode”: “Local”,
          “longitude”: 0.0,
          “latitude”: 0.0
      },
      “destLocation”: {
          “countryName”: “United States”,
          “countryCode”: “US”,
          “longitude”: −97.0,
          “latitude”: 38.0
      }
}
```

The foregoing metadata set is much richer than a conventional NetFlow type of metadata commonly used by other known security software-based tools. NetFlow essentially gives analysts what is commonly called a 5-tuple: source IP address and port number, destination IP address and port number and Layer 4 protocol. However, the present metadata collection may go as deep as the OSI stack, where its critical information is extracted from each traffic flow composed of a sequence of packets sent from a particular source to a particular unicast, anycast, or multicast destination that the source desires to label as a flow. The basic metadata set specifically collected is the flow's:
start time and end time,
source IP address, with port number, MAC address, country, city, longitude, latitude,
destination IP address, with port number, MAC address, country, city, longitude, latitude,
layer 4 protocol,
layer 7 application,
the application that uses flow such as Amazon Cloud, Google, Ebay, You Tube, etc.,
type of security,
number of packets captured,
number of bytes captured, and the
critical information specific to each flow type.

For DNS flows, the metadata collected also includes DNS queries, number of queries, time between each query, server error message, answers, canonical names and IP addresses in addition to the basic set.

For HTTP flows, the metadata collected also includes session history entries, such as method, referrer, host, path, cookie, and content type in addition to the basic set.

For DHCP flows, the metadata collected also includes transaction ID, server IP address, subnet, requested IP address, requested lease duration, requested renewal of lease duration, requested rebinding of lease duration, time DHCP_DISCOVER was made, time offer packet was made, time DHCP_REQUEST packet was made, time server declined request, time server replied with ACK, time server replied with NACK, time client sent DHCP_INFORM packet, and time client sent a release packet in addition to the basic set.

For SIP flows, the metadata collected includes uri of the caller, uri of the callee, call ID of the call in addition to the basic set.

For mail flows, the metadata collected includes the login user name, the password, sender of the email, recipient(s), cc recipients, bcc recipients, subject, date, initial sender, email header, comments, resent date, resent sender, SMTP tags, SMTP server reply, pop3 commands, and commands in addition to the basic set.

For SSL flows, the metadata collected includes SSL certificate information such as range of validity, country, postal code, city, organization name, and organizational unit of the certificate, and the primary domain of the SSL encryption in addition to the basic set.

Continuous extraction and storage of rich metadata enables network security professionals to quickly gain insights into their own network in many different ways. The following sub-sections provide details on different types of insights that can be derived by performing analytics on metadata on entities as collected from internal networks.

### 4.1 Understanding the Types of Traffic in Enterprise Networks

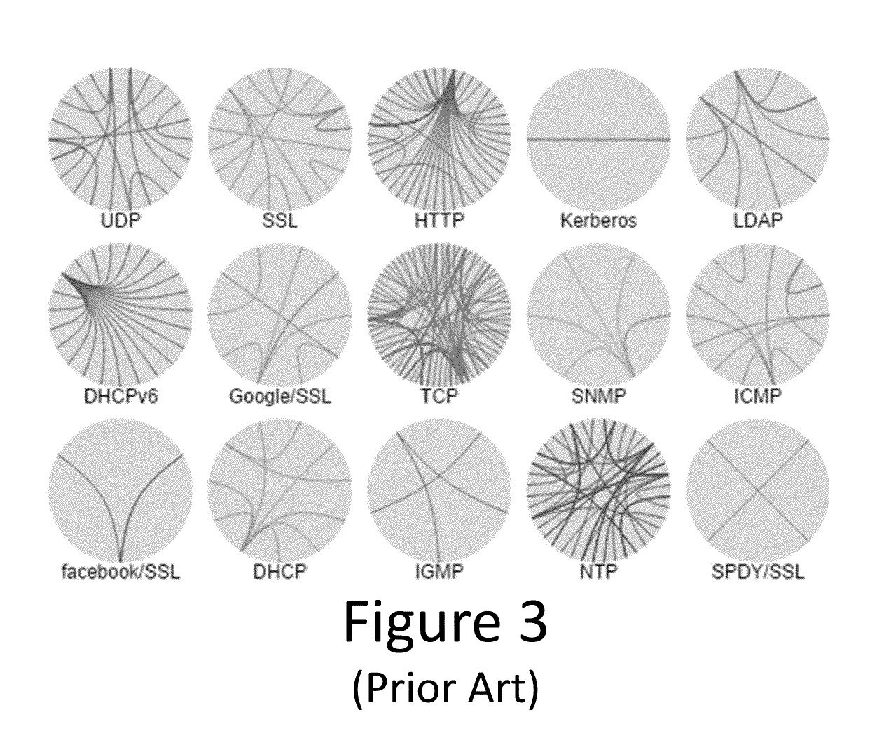

Network communication can happen using many different protocols and various implementations of protocols. Knowing the types of protocols and applications present on the network helps spot problem areas quickly without having to go through tedious searching through billions of packets or thousands of log files. As an example of network traffic patterns a metadata probe can provide consider the various network traffic patterns of FIG. 3.

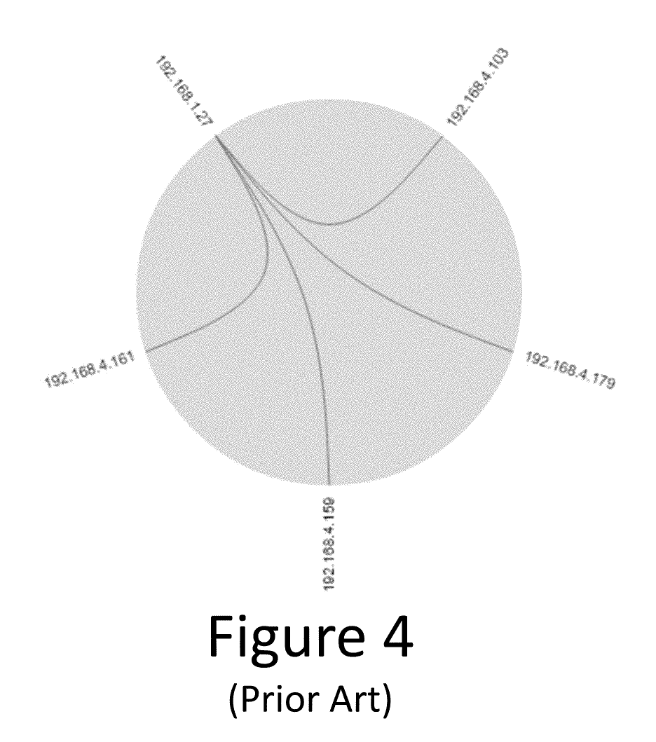

The images of FIG. 3 tell a security professional precisely what types of traffic are flowing through a network in a given period. If needed, one can even drill down and see which network entities communicate with each other using what types of protocols. FIG. 4 is an illustration visualizing network entities (as herein defined) using a specific protocol communicating with one another. Knowing the types of applications and protocols can help network security analysts quickly detect unwanted and/or suspicious traffic flows.

### 4.2 Understanding Relationship Between Network Entities

Rich metadata provides insights into the complex communication relationships between network entities, external or internal, in any given time period for any combinations of protocols and applications.

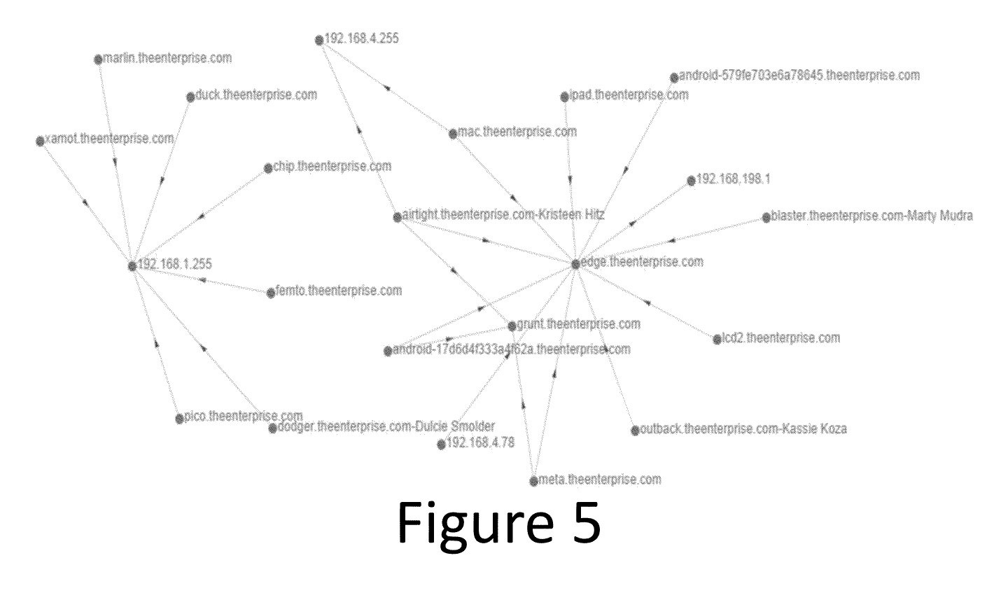

FIG. 5 is a typical relationship map generated based on DHCP and NETBIOS flows for a sample of the last five minutes on an internal test network from which rich metadata is extractable.

### 4.3 Tracking Unique IP Addresses in Enterprise Networks

Knowing the “actors” on a particular network can go a long way in helping security analysts quickly identify potential threats coming to that network or already in that network. By continuously monitoring the internal network and extracting the metadata of all traffic flows, one can keep track of a complete set of unique IP addresses. Using the GeoIP lookup tools, one can quickly identify where the network entity is geographically located. By leveraging the IP reputation information available from other third party sources, one can also automatically raise flags on certain new IP addresses observed for further investigation. It can help quickly detect malicious actors before they even do any harm to your network.

### 4.4 Automatically Determining the Roles of Network Entities

Based on a set of metadata records captured, one can also deduce the roles of network entities on the network. Examples of roles are: web server, file server, DNS server, DHCP server, LDAP server, HTTP client, etc. This determination is based purely on the type of network “conversations” (protocols and applications) and which side of the communication the network entity is on (server or client). This information, although simple, can contribute to identification of suspicious entities or traffic flows on the network. If a known dedicated file server is observed engaging in HTTP communication with another entity, such action would be a good reason to flag it for further monitoring or investigation. This flag function is built into the system according to the invention.

When certain network entities are deemed to be suspicious, further investigation would be useful. These entities are automatically monitored by the metadata probe. Automatic monitoring can take multiple forms including: selective full packet capture of the traffic from/to this entity. Another example would be the generation of alerts/notifications when the entity is observed by metadata probes communicating with other entities using certain application/protocol. The network rules or policies can be specifically designed for use only on an entity of interest, enabling capabilities to detect and notify any violations when the user is taking part into sensitive activities or attempting to hide it from detection, such as by encrypting it or modifying source documents.

### 4.6 Tracing Back to True Network Entity and Real Person Using DHCP, DNS and LDAP Protocols

There are two commonly used types of Internet Protocol (IP) traffic. These are TCP (Transmission Control Protocol) and UDP (User Datagram Protocol). Devices on a network use IP to communicate over the Internet or a local network. Much of the communication between these devices is done using various protocols, e.g., DNS, LDAP, DHCP, etc. These protocols incorporate the use of either TCP or UDP. As an example, both DNS and DHCP use UDP while LDAP uses TCP to communicate. As a result of identifying TCP and UDP on the network, protocols, application, and usage can be identified in network traffic flows. Network traffic flows in an IP network are fundamentally identified by IP addresses. IP addresses are important information to understand the details of network “conversations.” However, they are of limited use when the detection of security problems can only rely on more accurate information such as the identities of the true network devices that communicate with each other or the owners of those devices involved. This limitation is caused by the simple fact that IP addresses are often dynamic. Today's enterprise networks generally support hundreds or thousands of network devices. Manual static IP address assignment is a very time-consuming and error-prone operation. Adding to this fact, most computing devices are mobile, such as laptops, smart phones and tablets, where it is largely impractical to assign static IP addresses. Enterprise IT operations typically rely on DHCP as a mechanism to dynamically assign IP addresses. As a result, the association between an IP address and a network entity is rarely fixed. Using an IP address to determine the associated network entity is not reliable as the same IP address may be assigned to different entities at different times. Physical MAC addresses, which are by definition unique to all devices, and logical domain names assigned to network entities are more reliable information to help understand which entities are involved in network conversations. Most network entities are assigned to individual network users. Being able to trace back to the owners of network entities will truly help get to the bottom of the critical question: “who is talking to whom?” An accurate answer to this question enables the fast and accurate detection of security problems while making it possible to keep the false positives low.

### 4.6.1 Automatic IP Address to Domain Name Correlation (D NS)

By extracting metadata buried deep in network traffic, one can extract a valuable amount of IP-address-to-domain-name-mapping information that can help better understand network entities at domain name level rather than at IP level without having to perform explicit DNS reverse lookup. Deep metadata extraction method according to the invention enables the automatic discovery of relationships between IP addresses and the true network entity they represent. In the case of multiple IP addresses used for the same host, the inventive process removes yet another layer of ambiguity.

The following is an example of DNS flow metadata record captured according to the invention:

```
{
      “startTime”: 140970003814263537,
      “endTime”: 140970003814328065,
      “srcMac”: “00:17:C5:15:AC:C4”,
      “destMac”: “00:13:72:59:37:51”,
      “srcIp”: “192.168.2.143”,
      “destIp”: “192.168.1.5”,
      “srcPort”: 37576,
      “destPort”: 53,
      “protocol”: “UDP”,
      “app”: “DNS”,
      “hlApp”: “DNS”,
      “security”: “NONE”,
      “packetsCaptured”: 2,
      “bytesCaptured”: 216,
      “queries”: [{
          “qname”: “daisy.ubuntu.com”,
          “tId”: 30321,
          “answer”: [{
              “cname”: “daisy.ubuntu.com”,
              “ips”: [“91.189.92.55”,
                  “91.189.92.57”]
          }],
          “latency”: 64528
      }]
}
```

This metadata of a captured DNS flow shows that a device at IP address 192.168.2.143 issued a DNS query on “daisy.ubuntu.com”. A local DNS server responded using cached information or its own query to the next level DNS server. The domain name is mapped to two different IP addresses: 91.189.92.55 and 91.189.92.57. Noting the similarity of the IP addresses, it will be concluded that any communication originating or terminating at either of these two addresses is actually from the same network entity. This relationship definitely helps bringing additional visibility into network traffic flowing through the enterprise networks.

### 4.6.3 Accurate Correlation of Traffic Flow to True Computing Entity

Typical enterprise networks use DHCP to dynamically assign IP addresses to network devices attached to the network. The same IP address may be assigned to different devices at different times. Metadata extraction of network traffic flows enable automatic capturing of this assignment information dynamically and in real time. The following is an example of a DHCP flow metadata that was captured according to the invention:

```
{
      “startTime”: 140992594464622465,
      “endTime”: 140992594464622465,
      “srcMac”: “F8:B1:56:E4:25:C8”,
      “destMac”: “00:17:C5:15:AC:C4”,
      “srcIp”: “192.168.4.120”,
      “destIp”: “192.168.1.5”,
      “srcPort”: 68,
      “destPort”: 67,
      “protocol”: “UDP”,
      “app”: “DHCP”,
      “hlApp”: “DHCP”,
      “security”: “NONE”,
      “packetsCaptured”: 3,
      “bytesCaptured”: 1182,
      “transactionId”: 2150414685,
      “informTime”: 140992594464622465,
      “ackTime”: 140992594464654856,
      “serverIp”: “192.168.1.5”
}
```

By continuously capturing all DHCP flow metadata, a dynamic IP address at any given time can be mapped to the true network device identified by the source MAC address.

### 4.6.4 Correlation of Traffic Flows to Network Users

Insights into network activities can be gained by correlating flow metadata with network user information including the internal organization they belong to, the network devices they are assigned to and the logged-in users on each device. This information is available in existing directory services or IT auditing services widely used in enterprise networks. Correlating the network user information with traffic flows provides true insights and opens up possibilities for more powerful analysis and more accurate detection of security problems.

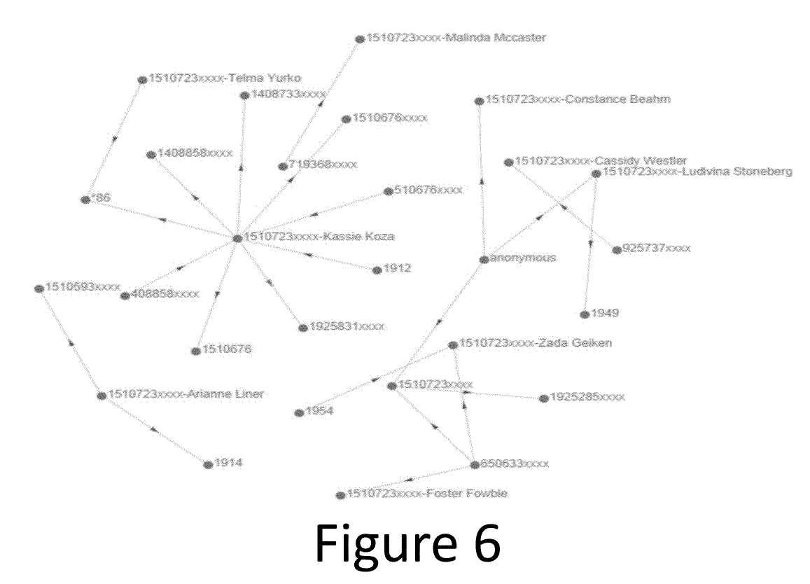

FIG. 6 is an example of VoIP call graph built from VoIP/SIP metadata captured in a test network for a 30-minute period.

The rich metadata extracted from DHCP flows gives the lease duration as well as IP and MAC address attached to the flow. Also extracted are the metadata for DNS flows to keep track of association between IP address-to-host name and MAC-address-to-domain name. From domain name, the employee that is responsible for the device can be associated or related. Also extracted are the SIP flows to obtain the phone numbers involved in a call. Hence, by using the above information, one can track the activities between network entities using phone number, IP address, MAC address, hostname for a given period of time.

The baselining approach of the present invention is a user-centric method. The user is defined to be the entity that creates network traffic. The entity may have a user name (a credential tied to an employee account, for instance); he may have multiple devices that he “normally” uses; he may be associated with “normal” activities, etc.

The initial list of parameters to be baselined by user is:

| Parameter | Protocols/Apps Used |
|---|---|
| Devices (the devices that the user utilizes) | DNS, LDAP |
| Geolocations (users and endpoints) | All (via IP Address lookup) |
| Protocols | TCP, UDP |
| Apps | TCP, UDP |
| Times (when events occur) | ALL |
| Account Info (e.g. usernames) | LDAP |
| Bandwidths | TCP, UDP |
| Topics (Subjects) | Mail |
| Domains | DNS |

Within the learning process, packets and flows are analyzed (classified and parsed), the attribute values are extracted, and those values are written to a database according to the user that they are associated with. Then a series of algorithms is provided to determine the normal behavior for the system. There is a finite set of algorithms and these can be easily added to over time. These algorithms determine such behavior baselines as what is the normal volume of X that occurs over time Y. In general, these algorithms are related to collecting numbers of events, volumes, and time. Some examples:
The normal apps of protocols seen on the network (or used by a user)
The normal login times for a user
The normal bandwidth utilized by a user over time

The final step is to detect the abnormal behaviors that may signify a network threat. As mentioned above, this can be automated or rules can be created to look for specific anomalies. Further, analyst feedback could be employed to mark certain alerts as false, increasing the accuracy of the detection over time.

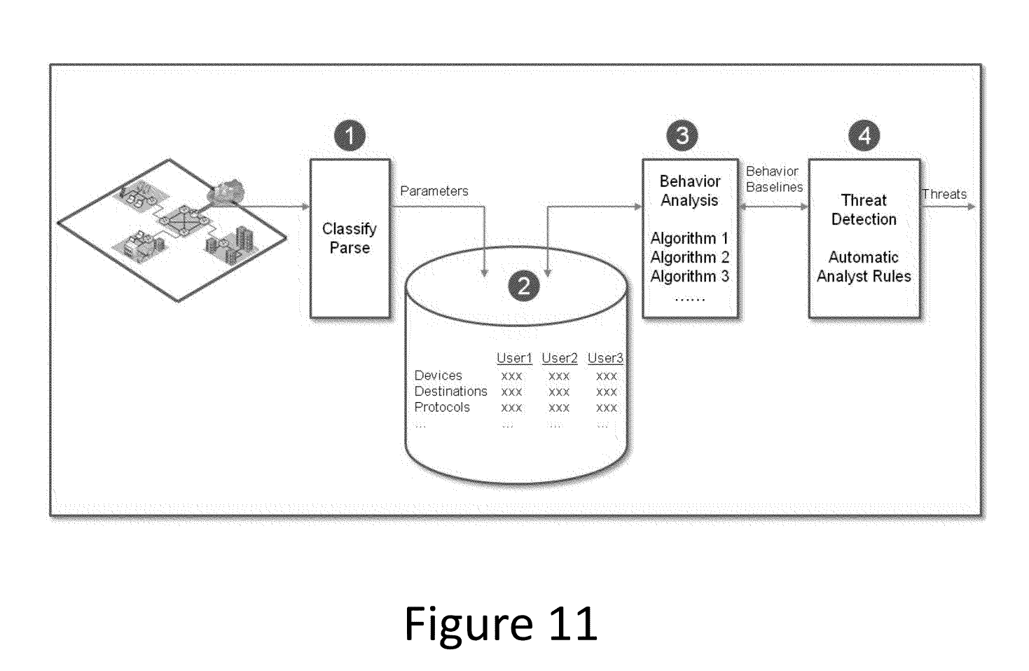

The four-step process according to the invention as described above is shown in FIG. 11 and summarized as follows:

1. DPI on the monitored traffic to extract the various events.

2. Write the baseline parameters to the database according to the user they are associated with.

3. Analyze the baseline parameters according to the algorithms to determine the baseline behaviors.

4. Detect deviations from the baseline by automation or analyst-defined rules.

### Hardware Architecture

To keep costs low for a device implementing the metadata probe function, a standard x86-based server may be used. Such devices can be manufactured and assembled by commercial suppliers such as SuperMicro or SMC. Key components of the server platform are a multi-core dual CPU such as the Intel Xeon E5-2695v2, 2.4 GHz or similar. Each CPU has 12 cores with a 30 MB cache. Each core supports two HyperThreads. This is to enable a reasonable number of true parallel processes. RAM size of 128 GB and a disk size of 16 TB raw disk capacity with RAID 10 configuration provides capacity and reliability. The internal bus is a type Gen 2 PCI-e bus and the operating system is for example Centos 6.5 installed on dual solid state drives. As explained below, one or more high-speed accelerator cards, such as the NT4E-NEBS four-port or the NT100E3-1-PTP high-speed single port cards (Napatech, Soeborg, Denmark), may be used to capture packets.

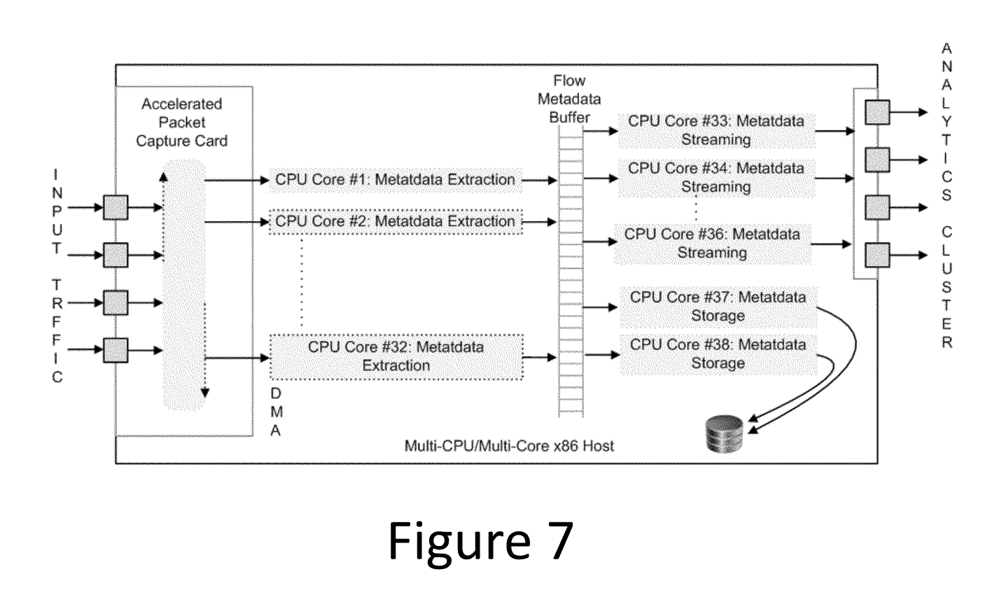

The architecture of the hardware as described is shown in FIG. 7.

### Software Architecture

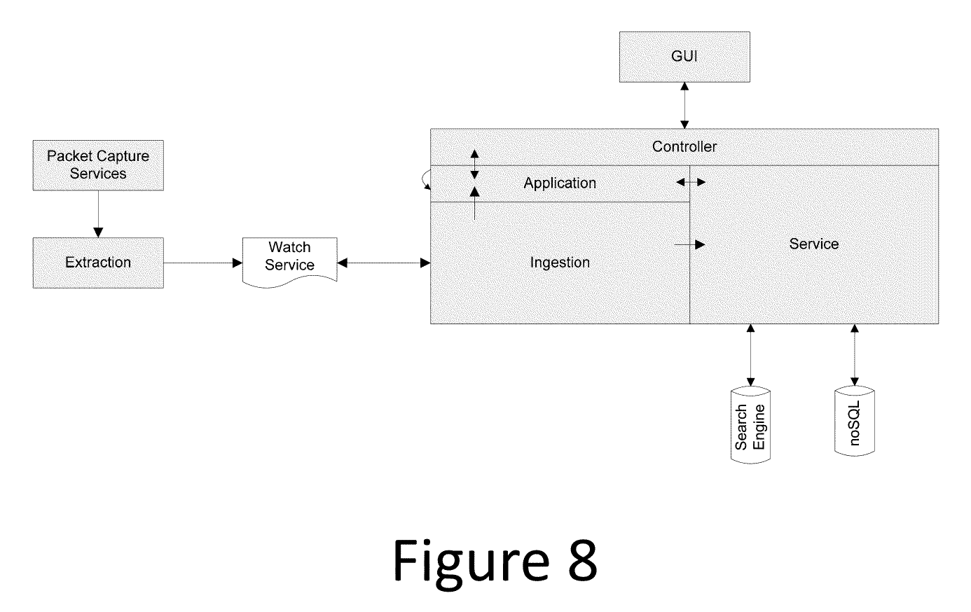

FIG. 8 illustrates the software architecture that might operate in the hardware environment of FIG. 7. Packets are processed by a specialized hardware accelerated capture card, such as a Napatech card loaded with Napatech services. The Napatech services organize these packets and feed them into an extraction module. The extraction module may be a deep packet inspection library, such as the Ipoque library, to create flows and obtain application information and more detailed flow information for that specific application. The extraction module creates a new JSON file every minute to store the flow data. The ingestion is then read in these files, which processes the data and persists them in a search engine, such as Solr and a noSQL database. (In computing, a persistent data structure is a data structure that always preserves the previous version of itself when it is modified. Such data structures are effectively immutable, as their operations do not (visibly) update the structure in-place, but instead always yield a new updated structure. A persistent data structure is not a data structure committed to persistent storage, such as a disk; this is a different and unrelated sense of the word “persistent.”) The ingestion also provides information for the application module to calculate its live data by publishing events. After processing this new information, the application publishes events to notify the GUI of the changes to be shown to an analyst or responsible process. Whenever there is a request from the GUI initiated by an analyst or other trigger, it is mapped to the controller (using Spring Framework). The controller queries the application module for the requested information. The application module then returns the requested information using the cache information or by querying the database through the service module. The search capability, DNS mapping, organizational mapping, relationship mapping, traffic graph generation, traffic pattern generation, monitoring module, timer services, etc. are inside the application module.

### Ingestion

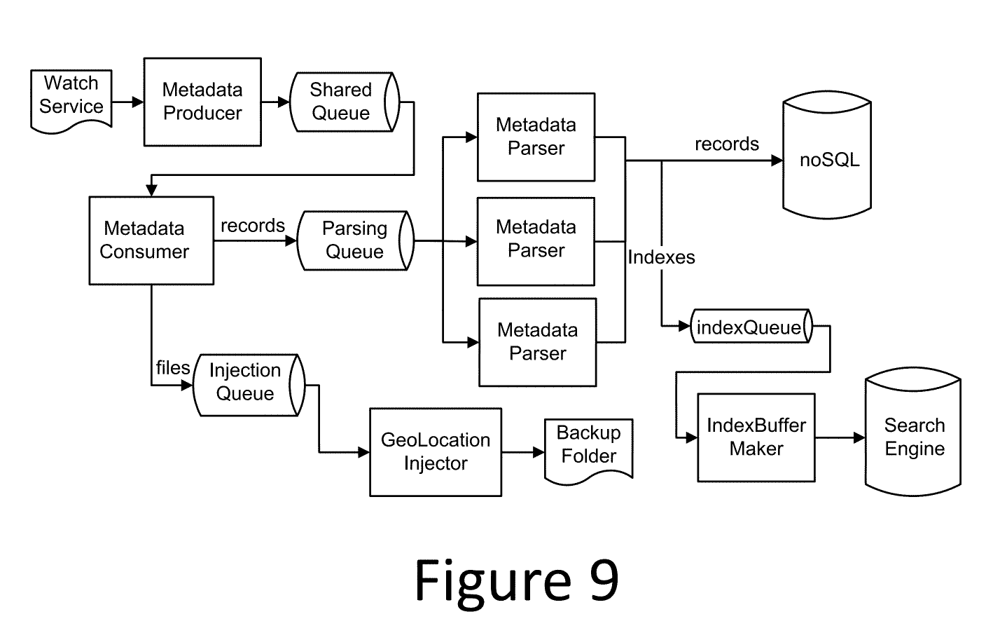

The extraction module (FIG. 8) is responsible for retrieving and processing packets and storing the information as flows within JSON files located within a specified directory called the watch directory (FIG. 8 and FIG. 9). Depending on the number of threads used to process packets, a number of directories will be present within the watch directory named by sequential numbers. The extractor generates a JSON file every minute as long as there is data to be flushed to file.

The MetadataProducer class (FIG. 9) is responsible for processing these files. In order to process these files, a Java WatchService is implemented to monitor each subdirectory within the watch directory. The WatchService can be configured to send out an event whenever a file is created, modified, and deleted. In this case, only when a new file is created is the event sent. The creation of a new file signals that the previous file will no longer be modified and hence the previous file can be ingested without dealing with any conflicts between the extractor and the server.

When a file is ingested, the file is placed within a sharedQueue to pass it to the MetadataConsumer class. The MetadataConsumer class proceeds to read the file line by line since the records are written in that format. Each line read is placed within the parsingQueue to prepare it for parsing. After every line is read, the file is then passed to the injectionQueue. If the backup setting is enabled, the GeoLocationInjector class takes the file, injects GeoLocation data into each record, and writes or appends the backup file into the specified backup folder. The original file is then destroyed.

### Parsing

Referring again to FIG. 9, because the record parsing/persisting time is much slower than the record reading time, it is best to multithread the parsing part of the server. The number of threads can be adjusted as seen fit. Each parser thread retrieves a record from the parsingQueue and converts the record into both a NoSQL data object and a search engine's data object. The NoSQL object contains every field of the record, whereas the search engine's data object only contains specific fields that are chosen to be indexed. The search engine's object is then placed into the solrQueue, while the NoSQL object is placed on a list for future batch processing. The MetadataParser then batch persists the NoSQL objects while the IndexBufferMaker persists the search engine's data objects. It has been initially observed that NoSQL persistence performs better multithreaded while search engine persistence performs better singlethreaded.

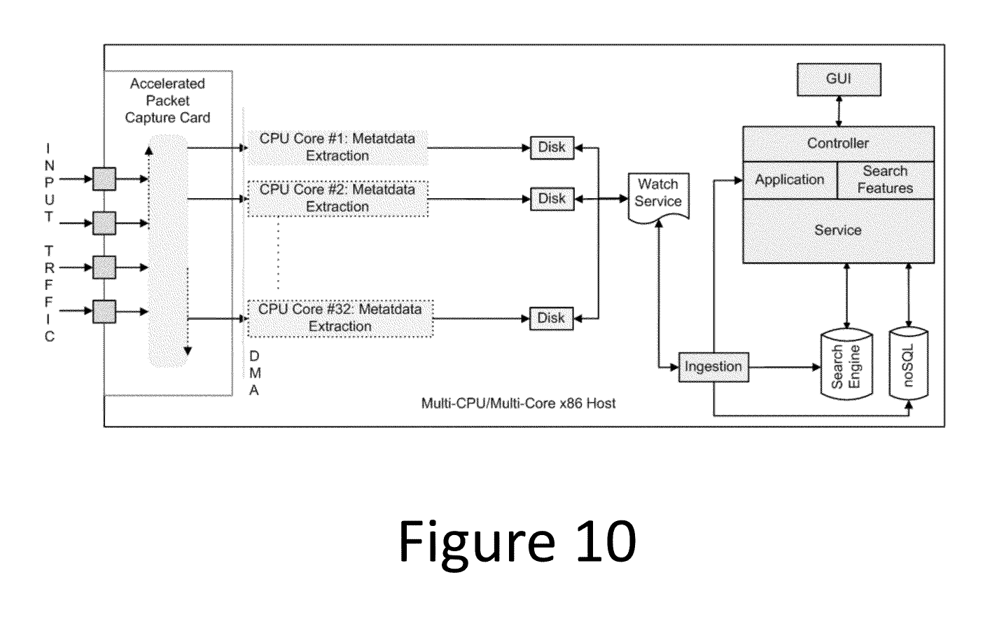

As discussed, it is a daunting prospect to compile and process metadata from cost, performance, and policy management/false positive standpoints. However according to the invention, by targeting smaller enterprise networks, the task is manageable. Shown in FIG. 10 is a consolidated architecture that simplifies management control, reduces system cost and improves performance using the novel metadata-based analysis. The hardware/software functions described in FIGS. 7 and 8 can be consolidated into a single chassis under unified management. This solution reduces a number of hardware gears and network traffic to forward extracted metadata to an external storage as well as their management.

### Internal Networks

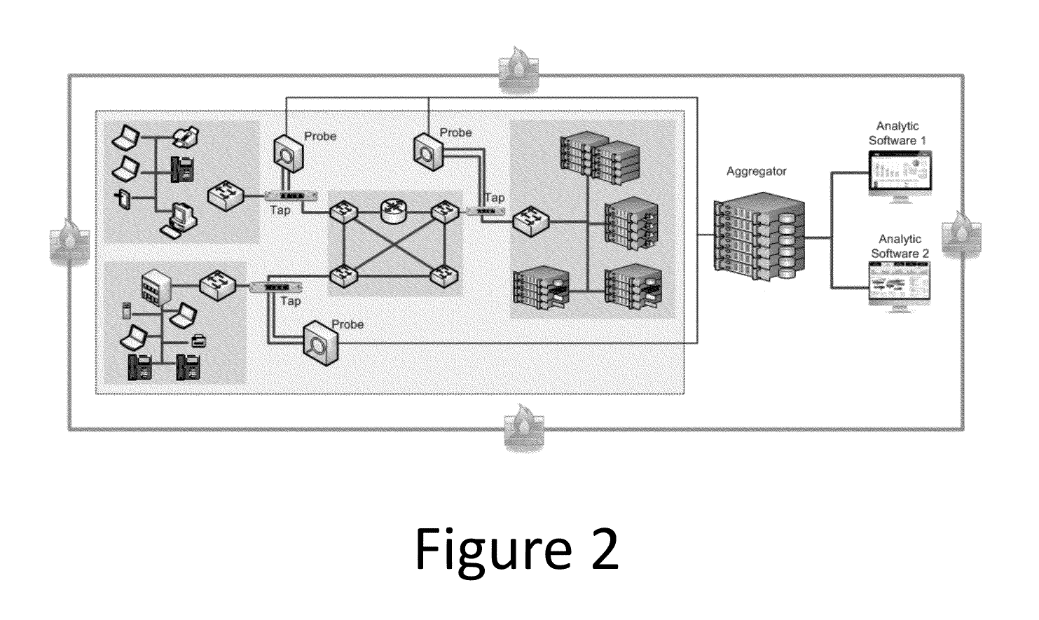

It is necessary to distinguish between internal and external actors in a network. Internal IP addresses have the prefix 192.168.x.x and 10.1.x.x. DNS flows have the domain name trailing the host name. A GEO-location look-up tool also indicates if an IP address is local or external. Key points in a network are the tap points. The tap points are typically at the switching location where sub-networks meet. FIG. 2 illustrates tap points in a network surrounded by a firewall. It is to be noted that networks can be virtualized so that the physical location of an actor can be remote from the physical locations of other actors.

The invention has been explained with reference to specific embodiments. Other embodiments will be evident to those of skill in the art. It is therefore not intended that this invention be limited, except as indicated by the appended claims.

What is claimed is:

1. A method for monitoring a computer network for external threats comprising:
employing a data processing application element on a processing apparatus with nonvolatile storage and a DNS server for:
tapping into network traffic at critical points of an internal data network;
providing direct links to bring tapped traffic to metadata probes;
causing the metadata probes to automatically extract rich metadata of traffic flow, the rich metadata being at least information found in headers of every layer of protocols associated with digital communication and describing communication between network entities;
aggregating the extracted metadata into a data cluster; and
providing an insight report on the data cluster to an output element for use by security analysts for analyzing dataflow for the external threats.

2. The method of claim 1 comprising:
employing the data processing application element for analyzing the rich metadata to produce stored data, for employing the stored data to generate a network entity model from organization information from an LDAP server, and then for comparing expected roles to the actual behaviors of the network entities for performing at least one of the following functions:
i) To flag suspicious behavior between similar entities on the basis of anomalies discovered in the rich metadata;
ii) To perform IP addresses-to-host-name correlation without making a reverse look-up to the DNS server using the DNS metadata;
iii) To map network-entity-to-IP addresses over a preselected time range using the metadata from DHCP flows; and
iv) To map IP addresses-to-network entities over a preselected time range using the metadata from DHCP flows.

3. The method of claim 1 comprising:
extracting from DHCP flow a metadata set taken from the list consisting of one or more of:
flow start time;
flow end time;
source IP address with port number, MAC address, country, city, longitude, latitude;
destination IP address with port number, MAC address, country, city, longitude, latitude;
layer 4 protocol;
layer 7 application;
transaction ID;
server IP address;
subnet;
requested IP address;
requested lease duration;
requested renewal of lease duration;
requested rebinding of lease duration;
time DHCP_DISCOVER was made;
time offer packet was made;
time DHCP_REQUEST packet was made;
time server declined request;
time server replied with ACK;
time server replied with NACK;
time client sent DHCP_INFORM packet; and
time client sent a release packet;
in order to test for suspicious and authorized IP addresses over different time ranges for a MAC address.

4. The method of claim 1 comprising:
extracting from DNS flows a set of metadata taken from the list consisting of one or more of:
the metadata start time;
the metadata end time;
source IP address with port number, MAC address, country, city, longitude, latitude;
destination IP address with port number, MAC address, country, city, longitude, latitude;
layer 4 protocol;
layer 7 application;
DNS queries; number of queries;
time between each query; and
server error message, answers, canonical names and IP addresses;
in order to map IP addresses to a hostname and hostname to IP address without making a DNS request to the DNS server.

5. The method of claim 1 including establishing a baseline dataset comprising the steps of:
examining monitored traffic to extract various events;
writing to the database according to an associated user baseline parameters based on the extracted events;
algorithmically analyzing the baseline parameters to determine the baseline behaviors;
establishing as flags deviations from the baseline by preselected defined rules.

6. An apparatus for monitoring a computer network for external threats comprising:
a device for capturing packet data traffic flow at at least one tap point in a network behind a firewall;
a data extraction element coupled to the tap point and operative to extract rich metadata, the rich metadata comprising the rich metadata being at least information found in headers of every layer of protocols associated with digital communication and describing communication between network entities, the data extraction element further operative to organize the rich metadata into information flows formed as data files;
a watch directory stored in nonvolatile digital storage for receiving and storing the rich metadata-containing information flow data files in at least one database;
an ingestion element coupled to receive the data files of organized and stored rich metadata-containing information flows and for persisting the rich metadata in at least one database;
an application element operative to analyze the rich metadata of the at least one database, wherein the application element is operative to distinguish between authorized network users and unauthorized network users on the basis of anomalies in the rich metadata; and
an input/output element for presenting analysis information from the application element and receiving queries of the rich metadata.
